(19) United States
(12) Patent Application Publication
(10) Pub. No.: US 2021/0319282 A1
(43) Pub. Date: Oct. 14, 2021

(54) ELECTRONIC DEVICE FOR CONTROLLING DATA PROCESSING OF MODULARIZED NEURAL NETWORK, AND METHOD FOR CONTROLLING SAME

(71) Applicant: Samsung Electronics Co., Ltd., Suwon-si, Gyeonggi-do (KR)

(72) Inventors: Myungjoo HAM, Suwon-si (KR); Jijoong MOON, Suwon-si (KR); Jinhyuck PARK, Yongin-si (KR); Hyoungjoo AHN, Suwon-si (KR); Geunsik LIM, Suwon-si (KR); Jaeyun JUNG, Suwon-si (KR)

(21) Appl. No.: 17/266,781

(22) PCT Filed: Oct. 4, 2019
(86) PCT No.: PCT/KR2019/013049

§ 371 Date: Feb. 8, 2021

(30) Foreign Application Priority Data
Oct. 17, 2018 (KR) 10-2018-0123799

(51) Int. Cl. G06N 3/04

(52) U.S. Cl. CPC G06N 3/04

(57) ABSTRACT

The disclosure provides an electronic device and a method for controlling same. The electronic device comprises: a memory; and a processor, connected to the memory, for controlling the electronic device, wherein the processor executes at least one command stored in the memory, and is thereby capable of controlling scheduling of data processing of a plurality of artificial intelligence models on the basis of at least one of a data processing speed and a connection structure of the plurality of artificial intelligence models.

### TECHNICAL FIELD

This disclosure relates to an electronic device and a method for controlling thereof. More particularly, the disclosure relates to an electronic device for controlling data processing of a modularized neural network and a method for controlling same.

### BACKGROUND ART

In recent years, technology for rapidly calculating large-scale data and technology for collecting data through a network have been developed, and artificial intelligence (AI) systems utilizing deep learning based on neural networks (NN) have been developed.

A neural network-based deep learning system is a computer system in which a machine learns and determines based on data, and a system for improving accuracy for the determination as the learning is accumulated. Here, the neural network layers and connects neurons between input and output.

There may be a problem that, even if a recognition rate of a neural network is degraded or an error occurs, a cause thereof may not be found easily. In that a main body of an operation of changing a flow of data in a neural network or adding a new neural network is a manager (or developer), there may be a problem that efforts, costs, and time are required as the neural network is advanced.

Accordingly, attempts have been made to modularize neural networks to facilitate partial replacement or alteration of neural networks. The modularized individual neural networks may be constructed by a framework or library such as Caffe, Tensorflow, PyTorch, Keras, etc. (hereinafter, referred to as a framework).

If a kind of the framework building individual neural networks is different or if the kind is the same but a version of the framework is different, when constructing a large-scaled neural network by combining individual neural networks, the compatibility between individual neural networks may have a problem.

Even if a pipeline is constructed for individual neural networks, it is difficult to synchronize the processed data in individual neural networks in that the individual neural networks are not constructed in consideration of the modularized environment, and there is a problem that resources for processing data in each individual neural networks may not be efficiently distributed.

### DISCLOSURE

### Technical Problem

The disclosure has been made to solve the above-described problems, and an object of the disclosure is to provide an electronic device which improves compatibility between neural networks based on heterogeneous frameworks when constructing a large neural network by combining individual neural networks and improving scheduling for data processing of individual neural networks, and a method for controlling thereof.

### Technical Solution

According to an embodiment, an electronic device includes a memory and a processor, connected to the memory, configured to control the electronic device, and the processor may, by executing at least one command stored in the memory, control scheduling of data processing of a plurality of artificial intelligence models based on at least one of a data processing speed and a connection structure of the plurality of artificial intelligence models.

The processor may, based on a first artificial intelligence model and a second artificial intelligence model, among a plurality of artificial intelligence models, having different data processing speeds being present in a same data path, control scheduling for data processing of the first and second artificial intelligence models based on a data processing speed of an artificial intelligence model with a slower data processing speed between the first and second artificial intelligence models.

The processor may, based on the second artificial intelligence model using output data of the first artificial intelligence model as input data and the data processing speed of the second artificial intelligence model being slower than the data processing speed of the first artificial intelligence model, control scheduling for data processing of the first and second artificial intelligence model based on the data processing speed of the second artificial intelligence models so that data that is most recently inputted with respect to a time at which the second artificial intelligence model outputs output data among the output data of the first artificial intelligence model inputted to the second artificial intelligence model as the input data.

The processor may, based on the first and second artificial intelligence models being present in different data paths and the output data of the first and second artificial intelligence models being merged to be used as input data of a third artificial intelligence model, among first to third artificial intelligence models with different data processing speeds, control scheduling for data processing of the first to third artificial intelligence models based on the data processing speed of the first to third artificial intelligence models.

The processor may, based on the data processing speed of the third artificial intelligence model, among the first to third artificial intelligence models, being fastest, and the data processing speed of the first artificial intelligence model being faster than the second artificial intelligence model, control scheduling for data processing of the first to third artificial intelligence models by copying output data of the second artificial intelligence model with relatively lower data processing speed, of the first and second artificial intelligence models, based on the processing speed of the first artificial intelligence model, and merging the output data of the first artificial intelligence model and the copied output data so as to be used as input data of the third artificial intelligence model.

The processor may, based on the data processing speed of the third artificial intelligence model, among the first to third artificial intelligence models, being fastest and the data processing speed of the first artificial intelligence model being faster than the data processing speed of the second artificial intelligence model, control scheduling for data processing of the first to third artificial intelligence models by merging output data that is most recently outputted with respect to a time at which the second artificial intelligence model outputs output data among the output data of the first artificial intelligence model based on the processing speed of the second artificial intelligence model and the output data of the second artificial intelligence model so as to be used as input data of the third artificial intelligence model.

The processor may, based on the data processing speed of the third artificial intelligence model, among the first to third artificial intelligence models, being slowest, control scheduling for data processing of the first to third artificial intelligence models by merging output data which is most recently outputted with respect to a time at which output data of the third artificial intelligence model, of the output data of the first artificial intelligence model and the output data of the second artificial intelligence model, is outputted so as to be used as input data of the third artificial intelligence model.

The processor may, based on first and second artificial intelligence models having different data processing speeds, among a plurality of artificial intelligence models, being present in different data paths, and the first and second artificial intelligence models using data of a source as input data, control scheduling for data processing of the first and second artificial intelligence models based on data processing speed of the first and second artificial intelligence models.

The processor may, based on data processing speed of the first artificial intelligence model being faster than the second artificial intelligence model, control scheduling for data processing of the source so that the data of the source is split based on the data processing speed of the first artificial intelligence model to be used as input data of the first and second artificial intelligence models.

The processor may, based on data processing of the first artificial intelligence model being faster than the second artificial intelligence model, control scheduling for data processing of the second artificial intelligence model so that data, which is most recently inputted with respect to a time at which the second artificial intelligence model outputs output data among the data of the source inputted to the second artificial intelligence model, is used as the input data.

According to an embodiment, a controlling method of an electronic device includes receiving input data of a plurality of artificial intelligence models, outputting output data which is obtained by processing the input data by the plurality of artificial intelligence models, and controlling scheduling of data processing of a plurality of artificial intelligence models based on at least one of a data processing speed and a connection structure of the plurality of artificial intelligence models.

The controlling the scheduling may include, based on a first artificial intelligence model and a second artificial intelligence model, among a plurality of artificial intelligence models, having different data processing speeds being present in a same data path, controlling scheduling for data processing of the first and second artificial intelligence models based on a data processing speed of an artificial intelligence model with a slower data processing speed between the first and second artificial intelligence models.

The controlling the scheduling may include, based on the second artificial intelligence model using output data of the first artificial intelligence model as input data and the data processing speed of the second artificial intelligence model being slower than the data processing speed of the first artificial intelligence model, controlling scheduling for data processing of the second artificial intelligence model so that data that is most recently inputted with respect to a time at which the second artificial intelligence model outputs output data among the output data of the first artificial intelligence model inputted to the second artificial intelligence model as the input data.

The controlling the scheduling may include, based on the first and second artificial intelligence models being present in different data paths and the output data of the first and second artificial intelligence models being merged to be used as input data of a third artificial intelligence model, among first to third artificial intelligence models with different data processing speeds, controlling scheduling for data processing of the first to third artificial intelligence models based on the data processing speed of the first to third artificial intelligence models.

The controlling the scheduling may include, based on the data processing speed of the third artificial intelligence model, among the first to third artificial intelligence models, being fastest, and the data processing speed of the first artificial intelligence model being faster than the second artificial intelligence model, controlling scheduling for data processing of the first to third artificial intelligence models by copying output data of the second artificial intelligence model with relatively lower data processing speed, of the first and second artificial intelligence models, based on the processing speed of the first artificial intelligence model, and merging the output data of the first artificial intelligence model and the copied output data so as to be used as input data of the third artificial intelligence model.

### Effect of Invention

According to various embodiments as described above, provided are an electronic device to improve compatibility between neural networks based on heterogeneous frameworks when constructing a large neural network by combining individual neural networks and improving scheduling for data processing of individual neural networks and a control method thereof.

### DESCRIPTION OF DRAWINGS

FIG. 1 is a block diagram of an electronic device according to an embodiment;

FIGS. 2 to 4 are diagrams to describe a path of data according to a structure of a plurality of artificial intelligence models;

FIGS. 5 and 6 are diagrams illustrating an embodiment in which a plurality of artificial intelligence models are applied; and

FIG. 7 is a flowchart according to an embodiment.

### BEST MODE FOR CARRYING OUT THE INVENTION

In describing the disclosure, a detailed description of known functions or configurations incorporated herein will be omitted as it may make the subject matter of the present disclosure unclear. In addition, the embodiments described below may be modified in various different forms, and the scope of the technical concept of the disclosure is not limited to the following embodiments. Rather, these embodiments are provided so that this disclosure will be thorough and complete, and will fully convey the scope of the disclosure to those skilled in the art.

However, it may be understood that the disclosure is not limited to the embodiments described hereinafter, but also includes various modifications, equivalents, and/or alternatives of the embodiments of the disclosure. In relation to explanation of the drawings, similar drawing reference numerals may be used for similar constituent elements.

As used herein, the terms “first,” “second,” or the like may denote various components, regardless of order and/or importance, and may be used to distinguish one component from another, and does not limit the components.

In this document, expressions such as “at least one of A [and/or] B,” or “one or more of A [and/or] B,” include all possible combinations of the listed items. For example, “at least one of A and B,” or “at least one of A or B” includes any of (1) at least one A, (2) at least one B, or (3) at least one A and at least one B.

A singular expression includes a plural expression, unless otherwise specified. In this disclosure, the terms “comprises” or “having” and the like are used to specify that there is a feature, number, step, operation, element, part or combination thereof described in the specification, but do not preclude the presence or addition of one or more other features, numbers, steps, operations, elements, parts, or combinations thereof.

In addition, the description in the disclosure that one element (e.g., a first element) is “(operatively or communicatively) coupled with/to” or “connected to” another element (e.g., a second element) should be interpreted to include both the case that the one element is directly coupled to the another element, and the case that the one element is coupled to the another element through still another element (e.g., a third element). On the other hand, when an element (e.g., a first element) is “directly connected” or “directly accessed” to another element (e.g., a second element), it can be understood that there is no other element (e.g., a third element) between the other elements.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” does not necessarily mean that a device is “specifically designed to” in terms of hardware. Instead, under some circumstances, the expression “a device configured to” may mean that the device “is capable of” performing an operation together with another device or component. For example, the phrase “a processor configured to perform A, B, and C” may mean a dedicated processor (e.g., an embedded processor) for performing the corresponding operations, or a generic-purpose processor (e.g., a central processing unit (CPU) or an application processor) that can perform the corresponding operations by executing one or more software programs stored in a memory device.

Hereinafter, embodiments of the disclosure will be described with reference to the accompanying drawings.

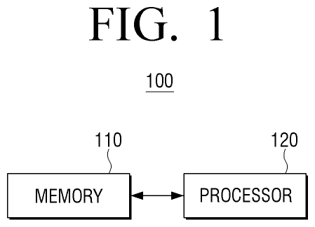

FIG. 1 is a block diagram of an electronic device according to an embodiment.

Referring to FIG. 1, an electronic device 100 includes a memory 110 and a processor 120.

The electronic device 100 may include at least one of, for example, and without limitation, tablet personal computer (PC)s, speakers, mobile phones, telephones, smartphones, electronic book readers, desktop PCs, laptop PCs, workstations, servers, a personal digital assistant (PDA), a portable multimedia player (PMP), a moving picture experts group phase 1 or phase 2 (MPEG-1 or MPEG-2) audio layer 3 (MP3) player, a medical device, a camera, a television, a digital video disk (DVD) player, a refrigerator, an air conditioner, a cleaner, an oven, a microwave, a washing machine, an air purifier, a set-top box, home automation control panels, security control panels, media box (e.g., Samsung HomeSync™, Apple TV™, or Google TV™), game consoles (e.g., Xbox™, PlayStation™), electronic dictionary, electronic key, camcorder, an electronic frame, a wearable device, or the like.

The electronic device 100 may be implemented as a system consisting of a combination of individual electronic devices as well as individual electronic devices. When the electronic device 100 is implemented as a system, the memory 110 and the processor 120 may be implemented in plural in a system. In the following description, it is assumed that the electronic device 100 is implemented as a separate electronic device.

The memory 110 may store various programs and data required for operation of the electronic device 100. The memory 110 may store at least one command or data related to the artificial intelligence model built by the framework. The framework may refer to software such as a developer tool to build an artificial intelligence model. As an example, the framework may be Caffe, Tensorflow, PyTorch, Keras, or the like.

The memory 110 may be implemented as a non-volatile memory, a volatile memory, a flash memory, a hard disk drive (HDD), a solid state drive (SSD), or the like. The memory 110 is accessed by the processor 120, and reading/writing/modifying/deleting/updating, or the like of data may be performed by the processor 120. In the disclosure, the term memory may include the memory 110, read-only memory (ROM) in the processor 120, random access memory (RAM), or a memory card (for example, a micro secure digital (SD) card, and a memory stick) mounted to the electronic device 100.

The processor 120 may control overall operations of the electronic device 100.

The processor 120 may control scheduling for data processing of a plurality of artificial intelligence models based on at least one of the data processing speed and the connection structure of the plurality of artificial intelligence models by executing at least one instruction stored in the memory.

The artificial intelligence model may refer to a machine learning or deep learning which is designed to learn a specific pattern using a computer and output resultant data using input data. As an example, the artificial intelligence model may be a neural network model, a genetic model, a probabilistic statistics model, etc. built by the framework. In particular, the plurality of artificial intelligence models may be artificial intelligence models established by different frameworks.

A controller (not shown) may learn and process data inputted into an artificial intelligence model by an artificial intelligence model and output the same. The controller may be implemented as a central processing unit (CPU), a graphic processing unit (GPU), an accelerated processing unit (APU), a neural processing unit (NPU), a tensor processing unit (TPU), or the like. According to another embodiment, the controller may be implemented as the processor 120. A main body for processing data in the artificial intelligence model may be variously modified and executed.

The processor 120 may control scheduling for data processing of a plurality of artificial intelligence models by executing at least one instruction stored in the memory 110. The at least one instruction stored in the memory 110 may be programmed so that the processor 120 may control the scheduling of data processing of the plurality of artificial intelligence models.

The controlling by the processor 120 the scheduling for the data processing may be at least one of controlling time and speed for performing the operation in which data is processed by the plurality of artificial intelligence models, determining data to be processed by the plurality of artificial intelligence models, or controlling to perform operations such as merging/copying/transmitting data, or the like.

The processor 120 may control scheduling for data processing of a plurality of artificial intelligence models based on at least one of data processing speed and connection structure of the plurality of artificial intelligence models.

The processor 120 may determine the data processing speed of the artificial intelligence model by monitoring the time at which data input by the artificial intelligence model is processed and outputted. According to another embodiment, the processor 120 may determine the data processing speed of the artificial intelligence model by comparing prestored information on the operation capability of the controller and information on the amount of operation required for processing the artificial intelligence model.

The data processing speed may refer to the time when the data input by the artificial intelligence model per unit data is processed and outputted. In this case, data processing speed may be represented by time (e.g., ms, s, etc.). However, this is only one embodiment, and the data processing speed may refer to the amount of data outputted by processing data inputted by the artificial intelligence model per unit time. For example, the data processing speed may be frames per second (fps), bits per second (bps) or the like.

The processor 120 may determine a connection structure of a plurality of artificial intelligence models based on a path (or stream) of input/output data. The connection structure of the plurality of artificial intelligence models may be composed of a serial structure or a parallel structure.

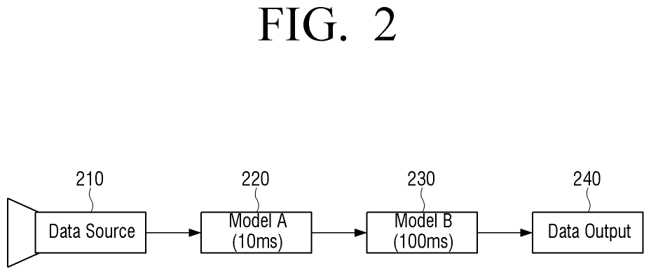

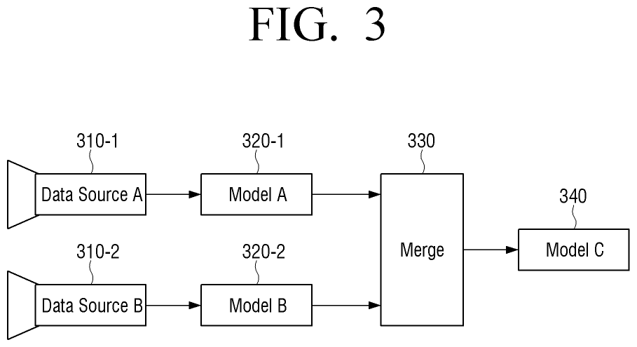

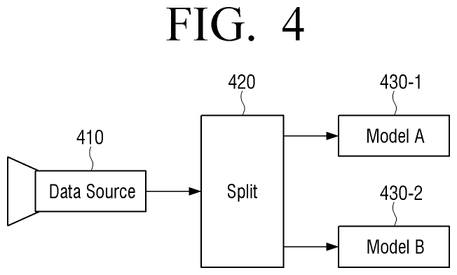

The serial structure may refer to a structure in which a plurality of artificial intelligence models are sequentially connected, as shown in FIG. 2, so that data outputted from one artificial intelligence model is transmitted as input data of another artificial intelligence model. As illustrated in FIG. 3, the parallel structure may have a structure in that a sink receiving the output data of a plurality of artificial intelligence models is the same, or a data source for transmitting input data to a plurality of artificial intelligence models is the same as shown in FIG. 4.

The processor 120 may control the time and speed of performing the operation in which data is processed by the plurality of artificial intelligence models according to the data processing speed of the plurality of artificial intelligence models and the connection structure of the plurality of artificial intelligence models, determine the data to be processed by the plurality of artificial intelligence models, or control to perform operations such as merging/copying/transmitting data, or the like.

Hereinbelow, referring to FIGS. 2 to 4, the data path according to the connection structure of a plurality of artificial intelligence models will be described in detail.

As shown in FIG. 2, according to a first embodiment, a first artificial intelligence model 220 and a second artificial intelligence model 230 of which data processing speed is different from each other among a plurality of artificial intelligence models may exist in the same data path.

The processor 120 may determine the connection structure of the first artificial intelligence model 220 and the second artificial intelligence model 230 as a serial structure based on the path (or stream) of the input/output data.

The processor 120 may control scheduling for data processing of the first and second artificial intelligence models 220 and 230 based on the data processing speed of the artificial intelligence model 230 of which the data processing speed of the first and second artificial intelligence models is slow.

The processor 120 may determine that the data processing speed of a first artificial intelligence model A 220 is 10 ms by monitoring the time when the data input from the data source 210 is processed by the first artificial intelligence model A 220 and output to the second artificial intelligence model B 230.

The processor 120 may determine that the data processing speed of the second artificial intelligence model B 230 is 100 ms by monitoring the time when the data input from the first artificial intelligence model A is processed by the second artificial intelligence model B 230 and output as a data output 240.

The processor 12 may compare the data processing speed of the first artificial intelligence model A 220 and the data processing speed of the second artificial intelligence model B 230. The processor 120 may determine a large-small relationship of the data processing speed of the first artificial intelligence model A 220 and the second artificial intelligence model B 230.

When the processor 120 identifies that the data processing speed of the second artificial intelligence model B 230 using the output data of the first artificial intelligence model A 220 is slower than the data processing speed of the first artificial intelligence model A 220, the processor 120 may control the time and speed to perform the operation in which data is processed by the first artificial intelligence model A 220 according to the data processing speed (100 ms) of the second artificial intelligence model B 230. For example, the processor 120 may control the data input to the first artificial intelligence model A 220 to be processed one by one at a speed of 100 ms according to the data processing speed (100 ms) of the second artificial intelligence model B 230.

The processor 120 may control the scheduling for data processing of the second artificial intelligence model 230 so that the second artificial intelligence model 230 uses the output data of the first artificial intelligence model 220 as input data, and when the data processing speed of the second artificial intelligence model 230 is slower than the data processing speed of the first artificial intelligence model 220, use the data which is input most recently with reference to the time point of outputting the output data by the second artificial intelligence model 230 as input data, among the output data of the first artificial intelligence model 220 input to the second artificial intelligence model 230.

For example, even if the data processing at a speed of 100 ms is performed in the first artificial intelligence model A 220, data processing speed of the first artificial intelligence model A 220 may be variable (e.g., 5 ms to 20 ms) and in this example, the first artificial intelligence model A 220 may process a plurality of data for 100 ms and transmit the data as input data to the second artificial intelligence model B 230.

The processor 120 may arrange a plurality of data not processed in the second artificial intelligence model B 230, among the plurality of output data of the first artificial intelligence model input to the second artificial intelligence model, into a queue in order of input.

In this example, the processor 120 may control the scheduling for data processing of the second artificial intelligence model 230 so that the processor 120 determine that the most recently inputted data is processed by the second artificial intelligence model 230 based on the time point when the second artificial intelligence model 230 outputs the output data among the plurality of data arranged in the queue. The processor 120 may remove the remaining data not determined to be processed by the second artificial intelligence model 230, among the plurality of data aligned in the queue so that it is not processed by the second artificial intelligence model 230.

In order to use the output data of the first artificial intelligence model A 220 to the input data of the second artificial intelligence model B 230, the processor 120 may convert the data input to the plurality of artificial intelligence models or the data output from the plurality of artificial intelligence models into a predetermined specification.

According to one embodiment, in the structure in which the first artificial intelligence model A 220 and the second artificial intelligence model B 230 are sequentially connected, if the data processing speed of the second artificial intelligence model B 230 is slower than the first artificial intelligence model A 220, by reducing the workload required to process data from the first artificial intelligence model A 220, efficiency of resources may be improved, and a bottleneck phenomenon that the unprocessed input data present in the queue of the second artificial intelligence model B 230 is accumulated over time and a phenomenon that frame differences are accumulated may be prevented.

As shown in FIG. 3, among the first to third artificial intelligence models 320-1, 302-2, and 340 having different data processing speeds according to the second embodiment, the first and second artificial intelligence models 320-1, 320-2 may be present in different data paths, and the output data of the first and second artificial intelligence models 320-1, 320-2 may be merge and used as input data for the third artificial intelligence model 340.

In this example, the processor 120 may determine the connection structure of the first and second artificial intelligence models 320-1, 320-2 as a parallel structure on the basis of a path of input/output data, and may determine the structure that the sink receiving the output data of the first and second artificial intelligence models 320-1, 320-2 is the same.

The processor 120 may merge a plurality of output data. The merge may refer to at least one of summing a plurality of data with one data (e.g., summing the RGB image and the IR image, combining the front/left/right/rear images to make a 360-degree image, or the like), and merging the plurality of data into one channel so that the plurality of data is received and transmitted together (e.g., generating a single stream composed of a plurality of images).

The processor 120 may demerge single data in which a plurality of output data are merged into a plurality of output data. The demerging may be an operation opposite to merging.

The processor 120 may control scheduling for data processing of the first to third artificial intelligence models 320-1, 320-2, 340 based on the data processing speed of the first to third artificial intelligence models 320-1, 320-2, 340. The processor 120 may control the time and speed for performing the operation in which data is processed by the first to third artificial intelligence models 320-1, 320-2, 340, determine the data to be processed by the first to third artificial intelligence models 320-1, 320-2, 340, or perform operations such as merging/copying/transmitting data, or the like.

The processor 120 may determine the data processing speed of the first to third artificial intelligence models 320-1, 320-2, 340 in the same manner as described above and may compare the data processing speed.

According to one embodiment, the data processing speed of the first to third artificial intelligence models 320-1, 320-2, 340 may be 10 ms, 100 ms, and 1 ms, respectively.

The processor 120 may compare the data processing speed of the first to third artificial intelligence models 320-1, 320-2, 340 and determine that the data processing speed of the third artificial intelligence model C 340 is fastest among the first to third artificial intelligence models 320-1, 320-2, 340.

According to one embodiment, the processor 120 may copy the output data of the second artificial intelligence model B 320-2 which has relatively slow data processing speed among the first and second artificial intelligence models 320-1, 320-2 based on the processing speed of the first artificial intelligence model A 320-1 which is faster among the first and second artificial intelligence models 320-1, 320-2.

The processor 120 may merge 330 the plurality of data processed in the first artificial intelligence model A 320-1 and the plurality of data processed in the second artificial intelligence model 320-2.

The processor 120 may copy the output data of the second artificial intelligence model B 320-2 in that the amount of output data of the second artificial intelligence model B 320-2 of which data processing speed is relatively slower is less than the amount of output data of the first artificial intelligence model A 320-1 of which data processing speed is relatively fast. The processor 120 may generate a copy of the output data by copying the meta data including information about the location where the output data is stored.

The processor 120 may control scheduling for data processing of the first to third artificial intelligence models by merging 330 the output data of the first artificial intelligence model and the copied output data so as to be used as input data of the third artificial intelligence model 340.

The processor 120 may merge the data processed in the first artificial intelligence model A 320-1 and data processed in the second artificial intelligence model 320-2 at a speed (10 ms) corresponding to the processing speed of the first artificial intelligence model A 320-1.

For example, the output data of the first artificial intelligence model A 320-1 may be output by ten, such as (A1), (A2), . . . , (A10), and the output data of the second artificial intelligence model B 320-2 may be output as one (B1).

The processor 120 may copy output data of the second artificial intelligence model B 320-2 to generate ten data of (B1), (B1), . . . , (B1) by copying the output data (B1) of the second artificial intelligence model B 320-2, and may correspond (A1), (A2), . . . , (A10) and (B1), (B1), . . . , (B1), respectively, to merge 330 ten data such as (A1, B1), (A2, B1), . . . , (A10, B1).

The processor 120 may control scheduling for data processing so as to input data (A1, B1), (A2, B1), . . . , (A10, B1), (A11, B2), (A12, B2) merged in this way into a third artificial intelligence model 340 at a speed corresponding to the processing speed of the first artificial intelligence model A 320-1.

As another embodiment, if the processor 120 determines that the data processing speed of the third artificial intelligence model C 340, among the first to third artificial intelligence model 320-1, 320-2, 340, is the fastest, and the data processing speed of the first artificial intelligence model A 320-1 is faster than the data processing speed of the second artificial intelligence model B 320-2, the processor 120 may control scheduling of the data processing of the first to third artificial intelligence models by merging 330 the output data most recently output, with respect to the time point that the second artificial intelligence model B 320-2 outputs the output data, among the output data of the first artificial intelligence model A 320-1, based on the processing speed of the second artificial intelligence model B 320-2, and the output data of the second artificial intelligence model B 320-2 to use the data as input data of the third artificial intelligence model.

Based on the slow processing speed of the second artificial intelligence model B 320-2 of the first and second artificial intelligence models 320-1, 320-2, the processor 120 may merge 330 the plurality of data processed in the first artificial intelligence model A 320-1 and the plurality of data processed in the second artificial intelligence model 320-2, respectively.

In that the amount of output data of the first artificial intelligence model A 320-1 of which data processing speed is relatively faster is relatively larger than the amount of output data of the relatively slow second artificial intelligence model B 320-2, the processor 120 may determine the most recently outputted output data based on the time when the second artificial intelligence model B 320-2 outputs the output data among the output data of the first artificial intelligence model A 320-1, and may merge 330 the determined output data and the output data of the second artificial intelligence model B 320-2.

For example, the output data of the first artificial intelligence model A 320-1 may be output by ten such as (A1), (A2), . . . , (A10) sequentially during the time 100 ms in which the second artificial intelligence model B 320-2 outputs one output data (B1).

The processor 120 may determine that the most recently outputted output data is (A10) at the time when the output data (B1) of the second artificial intelligence model B 320-2 is outputted among the output data (A1), (A2), . . . , (A10) of the first artificial intelligence model A 320-1, and may merge 330 (A10) and (B1) as (A10, B1).

The processor 120 may control scheduling for data processing so as to input merged data (A10, B1), (B20, B2) . . . into the third artificial intelligence model 340 at a speed corresponding to the processing speed of the second artificial intelligence model B 320-2.

As another embodiment, the data processing speed of the first to third artificial intelligence models 320-1, 320-2, and 340 are 10 ms, 100 ms, and 1 s, respectively.

As a result of comparing the data processing speed of the first to third artificial intelligence models 320-1, 320-2, and 340, the processor 120 may determine that the data processing speed of the third artificial intelligence model C 340 is the slowest among the first to third artificial intelligence models 320-1, 320-2, and 340.

The processor 120 may control scheduling for data processing of the first to third artificial intelligence models 320-1, 320-2, 340 by merging 330 the most recently outputted output data, with respect to the time to output the output data of the third artificial intelligence model 340 of the output data of the first artificial intelligence model A 320-1 to be used as input data of the third artificial intelligence model C 340.

Based on the data processing speed of the slowest third artificial intelligence model C 340 among the first through third artificial intelligence models 320-1, 320-2, 340, the processor 120 may merge 330 the plurality of data processed in the first artificial intelligence model A 320-1 and the plurality of data processed in the second artificial intelligence model 320-2, respectively.

The processor 120 may determine the most recently outputted output data based on the time when the third artificial intelligence model C 340 outputs the output data among the output data of the first and second artificial intelligence models 320-1 and 320-2, and may merge 330 the output data determined by the first and second artificial intelligence models 320-1 and 320-2 respectively.

For example, during the time is when the third artificial intelligence model C 340 outputs one output data (C1), the output data of the first artificial intelligence model A 320-1 may be 100 (A1), (A2), . . . , (A100) which is output sequentially, and output data of the second artificial intelligence model B 320-2 may be ten such as (B1), (B2), . . . , (B10) which is output sequentially.

The processor 120, based on the time is at which the output data (C1) of the third artificial intelligence model B 340 is output, may determine the most recently outputted output data (A100) among the output data (A1), (A2), . . . , (A100) of the first artificial intelligence model A 320-1, and may determine the most recently outputted output data (B10) among the output data (B1), (B2), . . . , (B10) of the second artificial intelligence model B 320-2.

The processor 120 may merge 330 the determine data (A100) and (B10) as (A100, B10).

The processor 120 may control scheduling for data processing so as to input the data (A100, B10), (A200, B20), . . . , merged in this way into the third artificial intelligence model 340 at a speed corresponding to the processing speed of the third artificial intelligence model C 340.

If the data processing speed of the first artificial intelligence model A 320-1 is slower than the data speed output from the data source A 310-1, the processor 120 may control scheduling for the data processing of the first artificial intelligence model A 320-1 in the same manner as controlling the scheduling for data processing of the second artificial intelligence model B 230 when the data processing speed of the second artificial intelligence model B 230, as illustrated in FIG. 2 is slower than the data processing speed of the first artificial intelligence model A 220.

As shown in FIG. 4, according to the third embodiment, the first and second artificial intelligence models 430-1 and 430-2 having different data processing speed, among a plurality of artificial intelligence models may be present in different data paths, and the first and second artificial intelligence models 430-1 and 430-2 may use the same source data as input data.

The processor 120 may determine the connection structure of the first and second artificial intelligence models 430-1, 430-2 as a parallel structure based on the path of the I/O data, and may determine that the data source 410 for transmitting input data from the first and second artificial intelligence models 430-1, 430-2 has the same structure.

The processor 120 may split 420 input data of the data source 410. The split 420 is an operation that is opposite to the merge, and may mean at least one of dividing one data into a plurality of data (e.g., dividing the 360-degree image as a front/left/right/rear image, etc.), and separating the plurality of data included in one channel.

The processor 120 may control the scheduling for data processing of the first and second artificial intelligence models 430-1, 430-2 based on the data processing speed of the first and second artificial intelligence models 430-1, 430-2. The processor 120 may control the time and speed of performing the operation in which the data is processed by the first and second artificial intelligence models 430-1, 430-2, may determine data to be processed by the first and second artificial intelligence models 430-1, 430-2, or may control to perform data copying/transmitting, or the like.

The processor 120 may determine and compare the data processing speed of the first and second artificial intelligence models 430-1 and 430-2 in the same manner as described above.

For example, if the data processing speed of the first artificial intelligence model 430-1 is 10 ms and the data processing speed of the second artificial intelligence model 430-2 is 100 ms, the processor 120 may determine that the data processing speed of the first artificial intelligence model 430-1 is faster than the data processing speed of the second artificial intelligence model 430-2.

The processor 120 may split 420 the input data of the data source 410 at a speed corresponding to the processing speed of 10 ms of the fast first artificial intelligence model A 430-1 between the first and second artificial intelligence models 430-1 and 430-2, and may control the scheduling of the data processing of the data source 410 to input the split data at a speed corresponding to the processing speed 10 ms of the first artificial intelligence model A 430-1 to the first and second artificial intelligence models 430-1, 430-2, respectively.

The processor 120 may align a plurality of data not processed in the second artificial intelligence model 430-2 to the queue in order to input data, among data inputted to the second artificial intelligence model 430-2 having a slow data processing speed between the first and second artificial intelligence models 430-1, 430-2.

The processor 120 may control the scheduling for data processing of the second artificial intelligence model 430-2 so that the processor 120 determine the most recently inputted data with respect to the time point of outputting the output data by the second artificial intelligence model 430-2, among a plurality of data aligned in a queue, as the input data to be processed by the second artificial intelligence model 430-2.

The processor 120 may remove the remaining data not determined to be processed by the second artificial intelligence model 430-2 among the plurality of data aligned in the queue to be removed from the queue so that it is not processed by the second artificial intelligence model 230 afterwards.

According to one embodiment, a phenomenon of a waste of resources, bottlenecks, and accumulation of frame differences that may be generated depending on the data processing speed differences of a plurality of artificial intelligence models in a structure in which a plurality of artificial intelligence models are connected in parallel may be reduced.

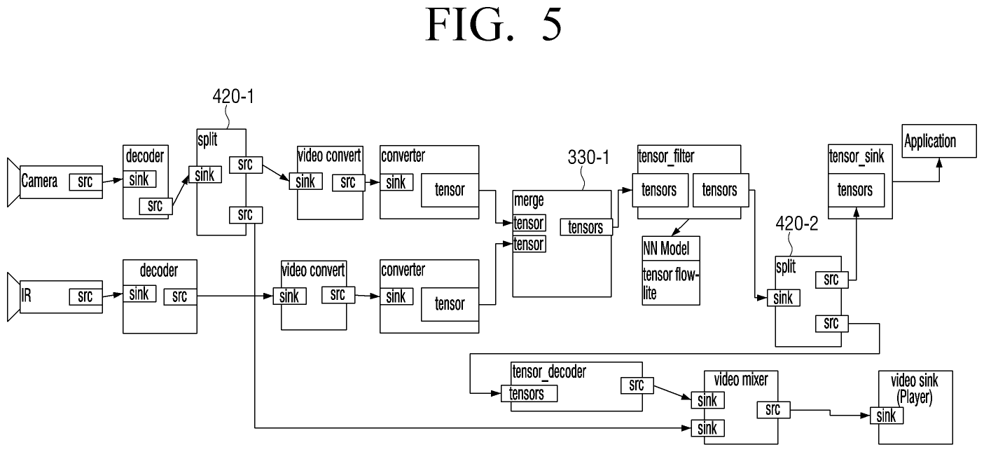

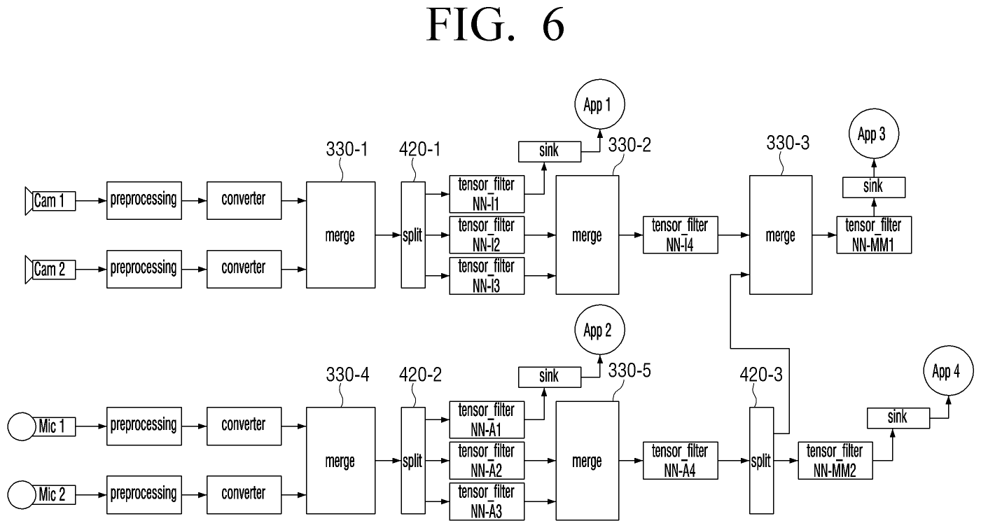

FIGS. 5 and 6 are diagrams illustrating an embodiment in which a plurality of artificial intelligence models are applied.

Referring to FIG. 5, data flow of an electronic device applied with an artificial intelligence model that merges the data of the RGB camera and the IR camera will be described.

The processor 120 may directly obtain the RGB and IR data of an image format from the RGB camera and the IR camera provided inside or outside of the electronic device 100. The processor 120 may decode the obtained RGB and IR data in the decoder, respectively.

The RGB camera may detect the intensity and the position of photons received through the lens to obtain the data in the image format. The IR camera may detect a temperature or an infrared (IR) to obtain data in the image format.

The camera illustrated in FIG. 5 is merely exemplary, and a path to obtain data may have various ways such as a microphone, a sensor, a network, or the like.

The microphone (not shown) may detect external sound and obtain data of a voice format.

The sensor (not shown) may obtain data by detecting the speed, direction, distance, etc. for the movement or rotation of the object. The sensor may be implemented as at least one of an acceleration sensor, a gyro sensor, a proximity sensor, a geometric sensor, a gravity sensor and a pressure sensor, or may be implemented as a motion sensor combining the above sensors. The sensor may directly detect the distance between the sensor and the object to obtain data. The sensor may be implemented as a laser sensor, a beam sensor such as an infrared sensor, and a radar.

The network may obtain data by performing communication with an external electronic device (not shown) by a communicator (not shown) of the electronic device 100.

The processor 120 may control to convert decoded RGB and IR data to normalized data (e.g., tensor data, etc.) with a normalized format to use the data of the media format as I/O data of the artificial intelligence model in the video converter and converter, respectively.

The processor 120 may split 420-1 the decoded RGB data to be input to the video mixer to synthesize or convert the image in the decoded RGB data and the RGB-IR data. The image transmitted to the video sink through the video mixer may be reproduced through a player.

The processor 120 may control to generate the RGB-IR data by merging 330-1 the data converted and input as the normalized data (e.g., tensor data, etc.).

The processor 120 may control the RGB-IR data to be processed in a tensor filter. The tensor filter may be a filter for standardization data, and may be a filter to enable use of the framework and the artificial intelligence model using the same. The tensor filter may process data inputted to the artificial intelligence model by the CPU, the GPU, the TPU, the VPU, the NPU, the processor 120, or the like.

The tensor filter may be applied to a general framework, an artificial intelligence model using the same, and a transformed binary.

The tensor filter may execute through static linking or perform through dynamic linking by deciding an object to be included in the execution time. In another embodiment, the tensor filter may execute while changing an object to be included in the execution time through dynamic loading.

When data is transmitted and received between a plurality of tensor filters, a plurality of tensor filters may be included in one process to transmit and receive data without the operation of writing to the memory.

The tensor filters may be included in different threads to operate asynchronously, or may operate in the same thread when connected to a single path.

The processor 120 may split 420-2 the RGB-IR data processed in a tensor filter and control to input a first stream to an application through the tensor sink and input another second stream to a video mixer through the tensor decoder.

In the case of the first stream, the processor 120 may process the normalized data in a tensor sink in a manner required for application, and may control the application to be efficiently forwarded to the application.

For the second stream, the processor 120 may convert the normalized data from a tensor decoder into data with the original media format and may control to be forwarded to the video mixer.

Referring to FIG. 6, the data flow of the electronic device applied with the artificial intelligence model will be described except the part overlapped with FIG. 5.

The processor 120 may obtain the data of an image format from a camera and may obtain data of a voice format from a microphone.

The processor 120 may convert the data in a media format to a normalized data (e.g., tensor data, etc.) in a converter, and the processor 120 may control performing preprocessing such as removing noise for each data, or the like.

The processor 120 may merge each normalized data 330-1 and 330-4, split 420-1, 420-2 the merged data, and transmit the split data to each tensor filter NN-I1, NN-I2, NN-I3, NN-A1, NN-A2, and NN-A3.

The processor 120 may control the data processed in the tensor filter NN-I1 and NN-A1 to be transmitted to the applications 1 and 2, respectively, through the tensor sink.

The processor 120 may merge 330-2 the data processed by the tensor filter NN-I2, NN-I3, merge 330-5 the data processed by the tensor filter NN-A2, NN-A3 to be transmitted to the tensor filter NN-I4, NN-A4, respectively.

The processor 120 may split 420-3 of the data processed in the tensor filter NN-A4, and control the first stream to forward the data processed through the tensor filter NN-MM2 to application 4, and control the second stream to be merged 330-3 with the data processed by the tensor filter NN-I4 to forward the data processed through the tensor filter NN-MM1 to application 3.

Though not illustrated in FIGS. 5 and 6, an operation of the processor 120 related thereto will be further described.

The processor 120 may reconfigure dimension information and scale, or the like, in a tensor transform (not shown). The tensor transform is able to process the data by, for example, the CPU, GPU, TPU, VPU, NPU, or the like.

The processor 120 may receive data of other formats other than data in the media format in a tensor source.

The processor 120 may store or load normalized data in the memory 110 from the tensor save or tensor load.

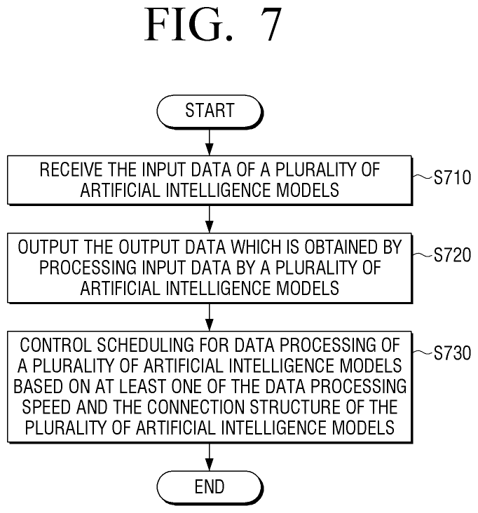

FIG. 7 is a flow chart according to an embodiment.

Referring to FIG. 7, the input data of a plurality of artificial intelligence models is received in operation S710.

The output data which is obtained by processing input data by a plurality of artificial intelligence models is output in operation S720.

A scheduling for data processing of a plurality of artificial intelligence models is controlled based on at least one of the data processing speed and the connection structure of the plurality of artificial intelligence models in operation S730. The data processing speed and a connection structure of a plurality of artificial intelligence models may be determined first. The connection structure may be a serial or a parallel structure.

According to a first embodiment, the controlling the scheduling may include controlling scheduling for data processing of the first and second artificial intelligence models based on data processing speed of the artificial intelligence model with slow data processing speed between the first and second artificial intelligence models, when the first and second artificial intelligence models having different data processing speed are present in the same data path.

The controlling the schedule may include controlling scheduling for data processing of the first and second artificial intelligence models to use the most recently input data as the input data with respect to the time point of outputting output data by the second artificial intelligence model among the output data of the first artificial intelligence model input to the second artificial intelligence model based on the processing speed of the second artificial intelligence model, based on the second artificial intelligence model using the output data of the first artificial intelligence model as input data and the data processing speed of the second artificial intelligence model being slower than the data processing speed of the first artificial intelligence model.

According to a second embodiment, the controlling may include scheduling for the data processing of the first to third artificial intelligence models based on the data processing speed of the first to third artificial intelligence models, when the first and second artificial intelligence models are present in different data paths, and output data of the first and second artificial intelligence model is merged and used as input data of the third artificial intelligence model, among the first to third artificial intelligence models having different data processing speed.

In one embodiment, the controlling the scheduling may include controlling scheduling for data processing of the first to third artificial intelligence models by, based on the data processing speed of the third artificial intelligence model, among the first to third artificial intelligence models, being fastest and the data processing speed of the first artificial intelligence model being faster than the second artificial intelligence model, copying output data of the second artificial intelligence model of which data processing speed is relatively slower between the first and second artificial intelligence models based on the processing speed of the first artificial intelligence model, merging the output data of the first artificial intelligence model and copied output data so as to be used as input data of the third artificial intelligence model.

As another embodiment, based on the data processing speed of the third artificial intelligence model being fastest among the first to third artificial intelligence models and the data processing speed of the second artificial intelligence model being faster than the second artificial intelligence model, the scheduling may include controlling scheduling for data processing of the first to third artificial intelligence models by merging the most recently outputted output data and the output data of the second artificial intelligence model with respect to the time point of outputting the output data by the second artificial intelligence model so that the merged data is used as the input data of the third artificial intelligence model.

As another embodiment, the controlling may include, based on the data processing speed of the third artificial intelligence model being slowest among the first to third artificial intelligence models, controlling scheduling for data processing of the first to third artificial intelligence models by merging the most recently outputted output data among the output data of the first artificial intelligence model and the output data of the second artificial intelligence model, with respect to the time point of outputting the output data of the third artificial intelligence model, so that the merged data is used as the input data of the third artificial intelligence model.

According to the third embodiment, the controlling the scheduling may include controlling the scheduling for data processing of the first and second artificial intelligence models based on the data processing speed of the first and second artificial intelligence models based on the first and second artificial intelligence models having different data processing speed being present in different data paths, and the first and second artificial intelligence models using the data of the same source as the input data.

The controlling the scheduling may include, based on the data processing speed of the first artificial intelligence model being faster than the second artificial intelligence model, controlling scheduling for data processing of the source by splitting the data of the same source based on the data processing speed of the first artificial intelligence model so as to input the split data into the first and second artificial intelligence model.

The controlling the scheduling may include, controlling the scheduling of the data processing of the second artificial intelligence model to use the most recently inputted data as input data based on the time when the second artificial intelligence model outputs the output data among the data of the same source input to the second artificial intelligence model when the data processing of the first artificial intelligence model is faster than the second artificial intelligence model.

The term “unit” or “module” used in the disclosure includes units consisting of hardware, software, or firmware, and is used interchangeably with terms such as, for example, logic, logic blocks, parts, or circuits. A “unit” or “module” may be an integrally constructed component or a minimum unit or part thereof that performs one or more functions. For example, the module may be configured as an application-specific integrated circuit (ASIC).

Various embodiments may be implemented as software that includes instructions stored in machine-readable storage media readable by a machine (e.g., a computer). A device may call instructions from a storage medium and operate in accordance with the called instructions, including an electronic apparatus (e.g., electronic device 100). When the instruction is executed by a processor, the processor may perform the function corresponding to the instruction, either directly or under the control of the processor, using other components. The instructions may include a code generated by a compiler or a code executable by an interpreter. The machine-readable storage medium may be provided in the form of a non-transitory storage medium. The “non-transitory” storage medium may not include a signal and is tangible, but does not distinguish whether data is permanently or temporarily stored in a storage medium.

According to some embodiments, a method disclosed herein may be provided in a computer program product. A computer program product may be traded between a seller and a purchaser as a commodity. A computer program product may be distributed in the form of a machine-readable storage medium (e.g., a CD-ROM) or distributed online through an application store (e.g., PlayStore™). In the case of on-line distribution, at least a portion of the computer program product may be stored temporarily or at least temporarily in a storage medium, such as a manufacturer's server, a server in an application store, a memory in a relay server, and the like.

Each of the components (for example, a module or a program) according to the embodiments may be composed of one or a plurality of objects, and some subcomponents of the subcomponents described above may be omitted, or other subcomponents may be further included in the embodiments. Alternatively or additionally, some components (e.g., modules or programs) may be integrated into one entity to perform the same or similar functions performed by each respective component prior to integration. Operations performed by a module, program, or other component, in accordance with the embodiments, may be performed sequentially, in a parallel, repetitive, or heuristic manner, or at least some operations may be performed in a different order, omitted, or other operations can be added.

What is claimed is:

1. An electronic device comprising:
a memory; and
a processor, connected to the memory, configured to control the electronic device,
wherein the processor is further configured to, by executing at least one command stored in the memory, control scheduling of data processing of a plurality of artificial intelligence models based on at least one of a data processing speed and a connection structure of the plurality of artificial intelligence models.

2. The electronic device of claim 1, wherein the processor is further configured to, based on a first artificial intelligence model and a second artificial intelligence model, among a plurality of artificial intelligence models, having different data processing speeds being present in a same data path, control scheduling for data processing of the first and second artificial intelligence models based on a data processing speed of an artificial intelligence model with a slower data processing speed between the first and second artificial intelligence models.

3. The electronic device of claim 2, wherein the processor is further configured to, based on the second artificial intelligence model using output data of the first artificial intelligence model as input data and the data processing speed of the second artificial intelligence model being slower than the data processing speed of the first artificial intelligence model, control scheduling for data processing of the second artificial intelligence model so that data that is most recently inputted with respect to a time at which the second artificial intelligence model outputs output data among the output data of the first artificial intelligence model inputted to the second artificial intelligence model as the input data.

4. The electronic device of claim 1, wherein the processor is further configured to, based on the first and second artificial intelligence models being present in different data paths and the output data of the first and second artificial intelligence models being merged to be used as input data of a third artificial intelligence model, among first to third artificial intelligence models with different data processing speeds, control scheduling for data processing of the first to third artificial intelligence models based on the data processing speed of the first to third artificial intelligence models.

5. The electronic device of claim 4, wherein the processor is further configured to, based on the data processing speed of the third artificial intelligence model, among the first to third artificial intelligence models, being fastest, and the data processing speed of the first artificial intelligence model being faster than the second artificial intelligence model, control scheduling for data processing of the first to third artificial intelligence models by copying output data of the second artificial intelligence model with relatively lower data processing speed, of the first and second artificial intelligence models, based on the processing speed of the first artificial intelligence model, and merging the output data of the first artificial intelligence model and the copied output data so as to be used as input data of the third artificial intelligence model.

6. The electronic device of claim 4, wherein the processor is further configured to, based on the data processing speed of the third artificial intelligence model, among the first to third artificial intelligence models, being fastest and the data processing speed of the first artificial intelligence model being faster than the data processing speed of the second artificial intelligence model, control scheduling for data processing of the first to third artificial intelligence models by merging output data that is most recently outputted with respect to a time at which the second artificial intelligence model outputs output data among the output data of the first artificial intelligence model based on the processing speed of the second artificial intelligence model and the output data of the second artificial intelligence model so as to be used as input data of the third artificial intelligence model.

7. The electronic device of claim 4, wherein the processor is further configured to, based on the data processing speed of the third artificial intelligence model, among the first to third artificial intelligence models, being slowest, control scheduling for data processing of the first to third artificial intelligence models by merging output data which is most recently outputted with respect to a time at which output data of the third artificial intelligence model, of the output data of the first artificial intelligence model and the output data of the second artificial intelligence model, is outputted so as to be used as input data of the third artificial intelligence model.

8. The electronic device of claim 1, wherein the processor is further configured to, based on first and second artificial intelligence models having different data processing speeds, among a plurality of artificial intelligence models, being present in different data paths, and the first and second artificial intelligence models using data of a source as input data, control scheduling for data processing of the first and second artificial intelligence models based on data processing speed of the first and second artificial intelligence models.

9. The electronic device of claim 8, wherein the processor is further configured to, based on data processing speed of the first artificial intelligence model being faster than the second artificial intelligence model, control scheduling for data processing of the source so that the data of the source is split based on the data processing speed of the first artificial intelligence model to be used as input data of the first and second artificial intelligence models.

10. The electronic device of claim 9, wherein the processor is further configured to, based on data processing of the first artificial intelligence model being faster than the second artificial intelligence model, control scheduling for data processing of the second artificial intelligence model so that data, which is most recently inputted with respect to a time at which the second artificial intelligence model outputs output data among the data of the source inputted to the second artificial intelligence model, is used as the input data.

11. A controlling method of an electronic device, the method comprising:
receiving input data of a plurality of artificial intelligence models;
outputting output data which is obtained by processing the input data by the plurality of artificial intelligence models; and
controlling scheduling of data processing of a plurality of artificial intelligence models based on at least one of a data processing speed and a connection structure of the plurality of artificial intelligence models.

12. The method of claim 11, wherein the controlling the scheduling comprises, based on a first artificial intelligence model and a second artificial intelligence model, among a plurality of artificial intelligence models, having different data processing speeds being present in a same data path, controlling scheduling for data processing of the first and second artificial intelligence models based on a data processing speed of an artificial intelligence model with a slower data processing speed between the first and second artificial intelligence models.

13. The method of claim 12, wherein the controlling the scheduling comprises, based on the second artificial intelligence model using output data of the first artificial intelligence model as input data and the data processing speed of the second artificial intelligence model being slower than the data processing speed of the first artificial intelligence model, controlling scheduling for data processing of the second artificial intelligence model so that data that is most recently inputted with respect to a time at which the second artificial intelligence model outputs output data among the output data of the first artificial intelligence model inputted to the second artificial intelligence model as the input data.

14. The method of claim 11, wherein the controlling the scheduling comprises, based on the first and second artificial intelligence models being present in different data paths and the output data of the first and second artificial intelligence models being merged to be used as input data of a third artificial intelligence model, among first to third artificial intelligence models with different data processing speeds, controlling scheduling for data processing of the first to third artificial intelligence models based on the data processing speed of the first to third artificial intelligence models.

15. The method of claim 14, wherein the controlling the scheduling comprises, based on the data processing speed of the third artificial intelligence model, among the first to third artificial intelligence models, being fastest, and the data processing speed of the first artificial intelligence model being faster than the second artificial intelligence model, controlling scheduling for data processing of the first to third artificial intelligence models by copying output data of the second artificial intelligence model with relatively lower data processing speed, of the first and second artificial intelligence models, based on the processing speed of the first artificial intelligence model, and merging the output data of the first artificial intelligence model and the copied output data so as to be used as input data of the third artificial intelligence model.
